(19) United States
(12) Patent Application Publication
(10) Pub. No.: US 2022/0182475 A1
(43) Pub. Date: Jun. 9, 2022

(54) DEVICE COMPRISING AN OPTICAL SENSOR

(71) Applicant: ISORG, Limoges CEDEX 3 (FR)

(72) Inventors: Benjamin BOUTHINON, GRENOBLE (FR); Pierre MULLER, GRENOBLE (FR); Wilfrid SCHWARTZ, GRENOBLE (FR); Agathe PUSZKA, GRENOBLE (FR); Quentin CHABLE, GRENOBLE (FR)

(21) Appl. No.: 17/599,480

(22) PCT Filed: Mar. 27, 2020
(86) PCT No.: PCT/EP2020/058866

§ 371 Date: Sep. 28, 2021

(30) Foreign Application Priority Data
Mar. 29, 2019 (FR) 1903347

(51) Int. Cl. H04M 1/02; G06V 40/13

(52) U.S. Cl. CPC H04M 1/0266; H04M 2250/12; G06V 40/1324; G06V 40/1318

(57) ABSTRACT

A device includes an at least partially transparent screen, an optical sensor and, between the sensor and the screen, a non-peripheral portion. The non-peripheral portion includes one or a plurality of rigid elements.

### RELATED APPLICATIONS

This application claims the priority benefit of French Patent application number 19/03347, the content of which is hereby incorporated by reference in its entirety.

### FIELD

The present disclosure generally relates to devices comprising an optical sensor under a screen.

### BACKGROUND

Many techniques of integration of an optical sensor under a partially transparent screen are known, for example, for the integration of a digital fingerprint sensor in a cell phone.

### SUMMARY

An embodiment overcomes all or part of the disadvantages of known sensors.

According to an aspect, an embodiment provides a device comprising:

an at least partially transparent screen;

an optical sensor; and

between the screen and the optical sensor, a layer having at least an optically clear portion with a refraction index smaller by at least 0.1 than the refraction index of an optical material of the optical sensor.

According to an embodiment, the optically clear portion is non-scattering.

According to an embodiment, the portion has a refraction index smaller by at least 0.15 than the refraction index of an optical material of the optical sensor.

According to an embodiment, the portion is made of air.

According to an embodiment, the portion is made of an adhesive with a low optical index or of a resin with a low optical index.

According to an embodiment, the layer further comprises at least one rigid element between the screen and the optical sensor.

According to an embodiment, a plurality of rigid elements is at least partially distributed at the surface of the optical sensor.

According to an embodiment, at least one rigid element is arranged between the microlenses of the optical sensor.

According to an embodiment, at least one rigid element is a pillar, and/or at least one rigid element is a tab.

According to an embodiment, the rigid element(s) have an identical height, said height being in the range from 1 to 300 micrometers, preferably from 1 to 150 micrometers, preferably from 1 to 50 micrometers.

According to an embodiment, the space between two rigid elements is in the range from 1 to 67 micrometers.

According to an embodiment, at least one rigid element is a support element between the screen and the optical sensor.

According to an embodiment, at least one rigid element is:

made of the same material as one of the optical materials of the optical sensor; and/or

made of a material filtering wavelengths in the range from 400 to 920 nm, preferably black; and/or

made of an electromagnetic shielding material; and/or

made of a resistive material; and/or

a piezoelectric.

According to an embodiment, the optical sensor has the same surface area as the screen.

According to an embodiment, the optical sensor has a surface area smaller than that of the screen.

According to an embodiment, the device comprises one or a plurality of pressure sensors.

According to an embodiment, the pressure sensor(s) are arranged at the periphery of the optical sensor and/or under the optical sensor and/or on the optical sensor.

According to an embodiment, the pressure sensor(s) are arranged under at least a portion of the rigid elements and/or the pressure sensor(s) are integrated to a rigid element.

According to an embodiment, the optical sensor is a fingerprint sensor.

According to an embodiment, the device comprises at least an infrared filter, having a cutoff wavelength at 600 nm and a 0.1% transmittance from 600 nm to 920 nm, arranged:

between said screen and said layer; and/or

between said screen and a screen protection glass; and/or

between said layer and the optical sensor; and/or

in the optical sensor.

According to another aspect, an embodiment provides a device, comprising:

an at least partially transparent screen;

an optical sensor; and

between the sensor and the screen, a non-peripheral portion comprising one or a plurality of rigid elements.

According to an embodiment, at least one rigid element is arranged between the microlenses of the optical sensor.

The rigid elements located, in the plane, between the microlenses, extend at least along the height of the microlenses.

According to an embodiment, at least one rigid element is a pillar.

According to an embodiment, at least one rigid element is a tab.

According to an embodiment, the rigid elements have an identical height, said height is in the range from 1 to 300 micrometers, preferably from 1 to 150 micrometers, preferably from 1 to 50 micrometers.

According to an embodiment, the space between two rigid elements is in the range from 1 to 67 micrometers.

According to an embodiment, at least one rigid element is a support element between the screen and the optical sensor.

According to an embodiment, at least one rigid element is made of a same material as one of the optical materials of the optical sensor.

According to an embodiment, at least one rigid element is made of a material filtering wavelengths in the range from 400 to 920 nm, preferably black.

According to an embodiment, at least one rigid element is made of an electromagnetic shielding material.

According to an embodiment, at least one rigid element is a piezoelectric element or is made of a resistive material.

According to an embodiment, the device further comprises, between the screen and the optical sensor, a layer having at least one non-scattering optically clear portion having a refraction index smaller by at least 0.1, preferably by at least 0.15, than the refraction index of an optical material of the optical sensor.

According to an embodiment, the non-scattering optically clear portion is:

made of air; or

made of an adhesive having a low optical index; or

made of a resin having a low optical index.

According to an embodiment, the optical sensor has the same surface area as the screen.

According to an embodiment, the optical sensor has a surface area smaller than that of the screen.

According to an embodiment, the device comprises one or a plurality of pressure sensors.

According to an embodiment, the pressure sensor(s) are arranged at the periphery of the optical sensor and/or under the optical sensor and/or on the optical sensor and/or under at least a portion of the rigid elements and/or are integrated to one or a plurality of rigid elements.

According to an embodiment, the optical sensor is a fingerprint sensor.

According to an embodiment, the device comprises at least one infrared filter, having a cutoff wavelength at 600 nm and a 0.1% transmittance from 600 nm to 920 nm, arranged:

between said screen and said layer; and/or

between said screen and a screen protection glass; and/or

between said layer and the optical sensor; and/or in the optical sensor.

An embodiment provides a cell phone comprising a device such as described.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a perspective view of a cell phone;

FIG. 2 is a partial cross-section view of an embodiment of a device comprising an optical sensor under a screen;

FIG. 3 is a partial cross-section view of another embodiment of a device comprising an optical sensor under a screen;

FIG. 4 is a cross-section view of an embodiment of a device comprising an optical sensor under a screen;

FIG. 5 is a cross-section view of another embodiment of a device comprising an optical sensor under a screen;

FIG. 6 is a cross-section view of another embodiment of a device comprising an optical sensor under a screen;

FIG. 7 is a cross-section view of still another embodiment of a device comprising an optical sensor under a screen;

FIG. 8 is a partial cross-section view of an embodiment of an angular filter and of an overlying interface layer;

FIG. 9 is a partial cross-section view of another embodiment of an angular filter and of an overlying interface layer;

FIG. 10 is a partial cross-section view of another embodiment of an angular filter and of an overlying interface layer;

FIG. 11 is a partial cross-section view of still another embodiment of an angular filter and of an overlying interface layer;

FIG. 12 is a simplified top view of an embodiment of a device comprising an optical sensor under a screen;

FIG. 13 is a simplified top view of another embodiment of a device comprising an optical sensor under a screen;

FIG. 14 is a simplified top view of another embodiment of a device comprising an optical sensor under a screen;

FIG. 15 is a simplified top view of still another embodiment of a device comprising an optical sensor under a screen;

FIG. 16 is a partial cross-section view illustrating a detail of an embodiment of a device comprising an optical sensor under a screen;

FIG. 17 is a cross-section view of an embodiment of a device comprising an optical sensor under a screen, further comprising a pressure sensor;

FIG. 18 is a cross-section view of another embodiment of a device comprising an optical sensor under a screen, further comprising a pressure sensor;

FIG. 19 is a cross-section view of another embodiment of a device comprising an optical sensor under a screen, further comprising a pressure sensor;

FIG. 20 is a cross-section view of still another embodiment of a device comprising an optical sensor under a screen, further comprising a pressure sensor;

FIG. 21 is a cross-section view of an embodiment of a device comprising an optical sensor under a screen, further comprising an infrared filter;

FIG. 22 is a cross-section view of another embodiment of a device comprising an optical sensor under a screen, further comprising an infrared filter; and

FIG. 23 is a cross-section view of still another embodiment of a device comprising an optical sensor under a screen, further comprising an infrared filter.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the assembling of the device has not been detailed.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

In the following description, “visible light” designates an electromagnetic radiation having a wavelength in the range from 400 nm to 700 nm and “infrared radiation” designates an electromagnetic radiation having a wavelength in the range from 700 nm to 1 mm. In infrared radiation, one can particularly distinguish near infrared radiation having a wavelength in the range from 700 nm to 1.4 micrometers.

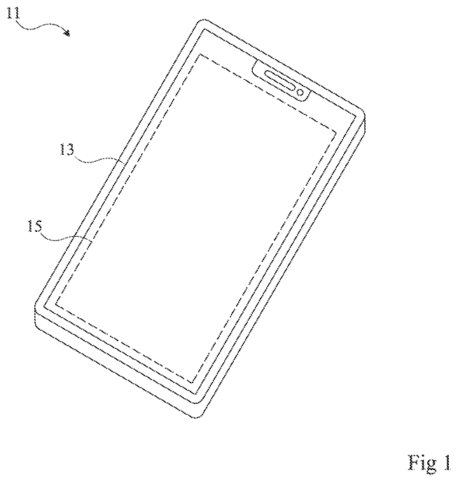

FIG. 1 is a perspective view of a cell phone 11.

Cell phone 11 is equipped with a device comprising a screen 13 and an optical sensor 15 arranged under screen 13. Optical sensor 15 is for example a fingerprint sensor. The optical sensor 15 such as illustrated in FIG. 1 has a surface area smaller than the surface area of screen 13. According to an alternative embodiment, the optical sensor and the screen have an identical surface area.

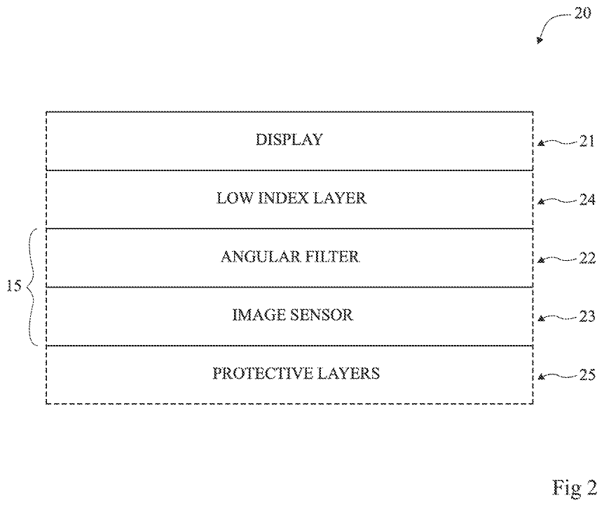

FIG. 2 is a partial cross-section view of an embodiment of a device 20 comprising an optical sensor under a partially transparent screen.

Device 20 comprises a succession of stacked layers of different natures.

A first layer 21, the upper layer in the orientation of the drawing, comprises a transparent screen (DISPLAY), for example, an OLED technology screen.

A second layer 22, arranged under first layer 21, comprises an angular filter (ANGULAR FILTER).

A third layer 23, arranged under second layer 22, comprises an image sensor (IMAGE SENSOR).

Between first layer 21 and second layer 22, a fourth layer 24 comprises at least one optically clear wall (LOW INDEX LAYER). According to an alternative embodiment, this portion is included in second layer 22.

Second layer 22 and third layer 23 form together optical sensor 15.

Fourth layer 24 forms an optical interface between first layer 21 and second layer 22.

Optionally, the assembly is supported by a base stack 25 (PROTECTIVE LAYERS).

The screen of first layer 21 is for example partially transparent and has a transmittance from 0.5 to 4% at 530 nm. First layer 21 may further comprise:

a protective layer (not shown) arranged on the screen, for example, made of tempered glass; and/or

an infrared filter (not shown in FIG. 2), arranged either under the screen or between the protective layer and the screen.

The angular filter of second layer 22 comprises:

microlenses; and/or

a layer having microopenings.

The image sensor of third layer 23 is for example a sensor comprising organic photodiodes (OPDs) integrated on a substrate with CMOS transistors or a substrate with thin-film transistors (TFTs). The sensor comprising organic photodiodes is for example made of a mixture of poly(3,4-ethylenedioxythiophene) (PEDOT) and of sodium poly(styrene sulfonate) (PSS). The substrate is for example made of silicon, preferably, of single-crystal silicon. TFT transistors are for example made of amorphous silicon (a-Si), of indium gallium zinc oxide (IGZO), or of low temperature polysilicon (LIPS).

Image sensor 23 is preferably sensitive to the wavelengths of the visible spectrum and of near infrared, that is, to wavelengths in the range from 400 to 920 nm. Sensor 23 is preferably sensitive to wavelengths transmitted by an OLED screen (RGB), particularly blue and green in the wavelength range from 490 nm to 570 nm.

According to the described embodiment, the optically clear portion of fourth layer 24 is at least transparent in the wavelengths emitted by the OLED display screen, particularly blue and green. The optically clear portion has a refraction index smaller by at least 0.1, preferably by at least 0.15, than the refraction index of an optical material of optical sensor 15, in contact with layer 24. The optical material of optical sensor 15 typically has a refraction index in the range from 1.5 to 1.6. The optical clear portion is for example, an air layer, a resin layer with a low refraction index, or a layer of an adhesive with a low refraction index (LOCA or Liquid Optically Clear Adhesive), typically in the range from 1.34 to 1.5. In the following description, an optical or refraction index is called “low” when it is smaller than 1.5, and “high” when it is greater than or equal to 1.5. The resin having a low optical index and the adhesive having a low refraction index are for example colored and thus allow a wavelength filtering. Stack 25 (PROTECTIVE LAYERS) comprises a plurality of elements such as for example:

a shielding layer, for example, made of copper; and/or

a heat dissipation layer, for example, made of graphite; and/or

a shock absorption layer (or “cushion”).

Adhesive layers enabling to bond all or part of the layers together may be present but have not been shown. Preferably, in particular if the adhesive is arranged above the image sensor, the adhesive is optically clear (Optically Clear Adhesive, OCA) and non-scattering. In the sense of the present disclosure, it is considered that a material is “non-scattering” if it deviates a light beam by less than approximately 3.5 degrees, preferably by less than 3.5 degrees, from its initial direction.

The peripheral portion of the device has not been shown in FIG. 2 and will be detailed later on.

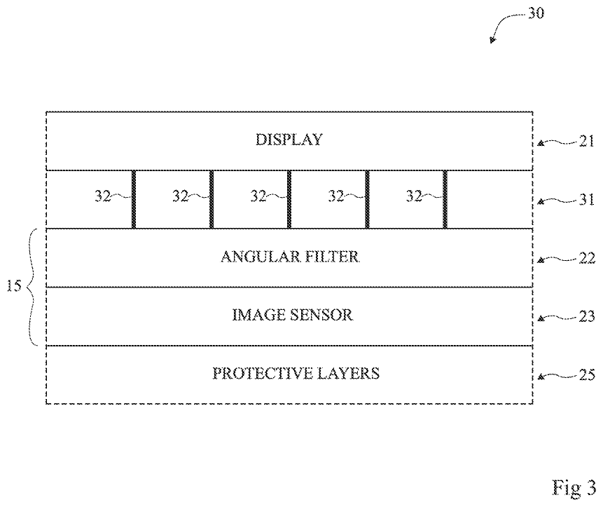

FIG. 3 is a partial cross-section view of another embodiment of a device 30 comprising an optical sensor under a partially transparent screen.

Device 30 comprises a succession of stacked layers of different natures.

A first layer 21, the upper layer in the orientation of the drawing, comprises a transparent screen (DISPLAY), for example, an OLED technology screen.

A second layer 22, arranged under first layer 21, comprises an angular filter (ANGULAR FILTER).

A third layer 23, arranged under second layer 22, comprises an image sensor (IMAGE SENSOR).

Between first layer 21 and second layer 22, a level 31 comprises one or a plurality of rigid elements 32.

Second layer 22 and third layer 23 form together optical sensor 15.

Level 31 forms, at least between the rigid element(s), an optical interface between first layer 21 and second layer 22.

Optionally, the assembly is supported by a base stack 25 (PROTECTIVE LAYERS).

In the same way as for the embodiment of FIG. 1, the screen of first layer 21 is for example partially transparent, having a transmittance from 0.5 to 4% at 530 nm. First layer 21 may further comprise:

a protective layer (not shown) arranged on the screen, for example, made of tempered glass; and/or

an infrared filter (not shown in FIG. 3), arranged either under the screen or between the protective layer and the screen.

The angular filter of second layer 22 comprises:

microlenses; and/or

a layer having microopenings.

The image sensor of third layer 23 is, in the same way as in the embodiment of FIG. 2, for example a sensor comprising organic photodiodes (OPDs) integrated on a substrate with CMOS transistors or a substrate with thin-film transistors (TFT). The sensor comprising organic photodiodes is for example made of a mixture of poly(3,4-ethylenedioxythiophene) (PEDOT) and of sodium poly(styrene sulfonate) (PSS). The substrate is for example made of silicon, preferably, of single-crystal silicon. TFT transistors are for example made of amorphous silicon (a-Si), of indium gallium zinc oxide (IGZO), or of low temperature polysilicon (LIPS).

The rigid element(s) 32 of level 31 extend all along the height of the level to be in contact with first layer 21 and second layer 22. The rigid elements are here shown as pillars, but may take other shapes, for example, of tabs, of honeycomb structures, etc.

Stack 25 (PROTECTIVE LAYERS) comprises a plurality of elements such as for example:

a shielding layer, for example, made of copper; and/or

a heat dissipation layer, for example, made of graphite; and/or

a shock absorption layer (or “cushion”).

Adhesive layers enabling to bond all or part of the layers together may be present but have not been shown. Preferably, in particular if the adhesive is arranged above the image sensor, the adhesive is optically clear (Optically Clear Adhesive, OCA) and non-scattering.

The peripheral portion of the device has not been shown in FIG. 3 and will be detailed hereafter.

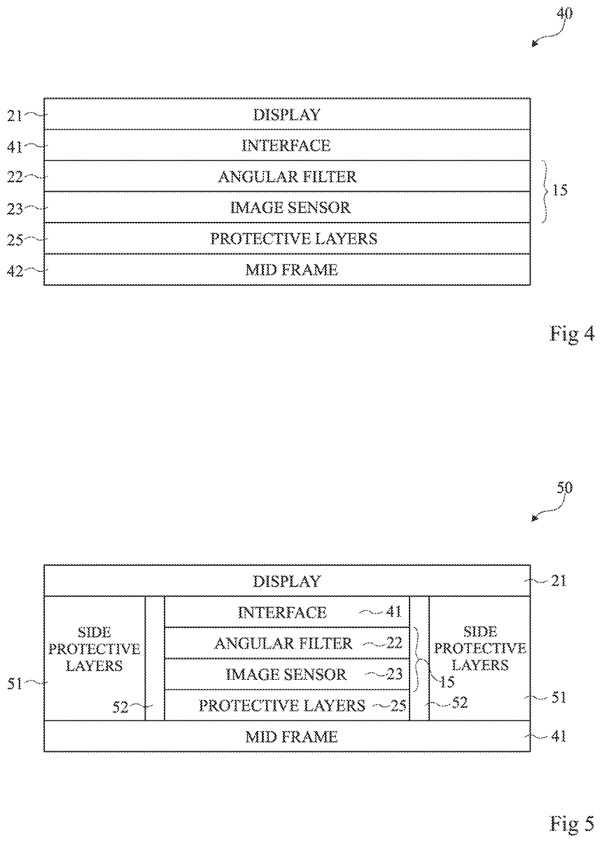

FIG. 4 is a cross-section view of an embodiment of a device 40 comprising an optical sensor 15 under a partially transparent screen 13.

According to the embodiment shown in FIG. 4, optical sensor 15 has a surface area identical to that of screen 13.

Device 40 comprises a succession of stacked layers, having an identical surface area, but of different natures.

The first, second, and third layers 21, 22, and 23 are identical or similar to those described in relation with FIGS. 2 and 3.

Between first layer 21 and second layer 22, an interface layer 41 (INTERFACE) comprises at least an optically clear portion, one or a plurality of rigid elements, or a combination thereof.

A stack 25, identical or similar to that described in relation with FIGS. 2 and 3, may be located under all four layers 21, 41, 22, and 23.

Stack 25 rests, in this example, on a frame 42 (MID FRAME).

In the case of an integration of device 40 in a cell phone, frame 42 is for example an intermediate frame, that is, located between the screen and the back of the cell phone, more particularly between the screen and the battery. For example, frame 42 comprises the printed circuit board of the cell phone, on the surface opposite to that where the image sensor would be arranged.

FIG. 5 is a cross-section view of another embodiment of a device 50 comprising an optical sensor under a partially transparent screen.

In the device 50 shown in FIG. 5, the intermediate layers of the device, that is, interface layer 41, second layer 22, third layer 23, and stack 25, have a surface area equal to or smaller than that of the external layers, that is, first layer 21 and frame 42.

Further, peripheral stacks 51 (SIDE PROTECTIVE LAYERS) are arranged on each side of intermediate layers 41, 22, 23, and 25. Peripheral stacks 51 extend vertically all along the height between external layers 21 and 42. Peripheral stacks 51 extend horizontally from the peripheral end of device 50 all the way to a limit close to the intermediate layers, to leave a space 52 between the intermediate layers and peripheral stacks 51. Space 52 is for example filled with air or resin.

Peripheral stacks 51 for example have a function of support of the first layer 21 comprising the screen on frame 42. The internal layers are then bonded to the screen and/or to frame 42.

Peripheral stacks 51 comprise the same elements as those previously described for stack 25. Further, peripheral stacks 51 may comprise peripheral spacers easing the assembly on the frame (MID FRAME).

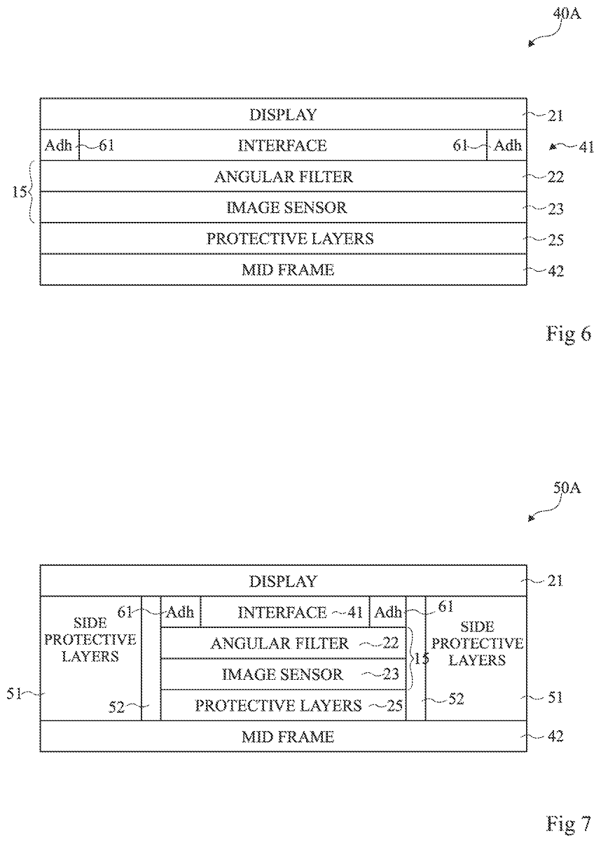

FIG. 6 is a cross-section view of another embodiment of a device 40A comprising an optical sensor under a partially transparent screen.

The device 40A shown in FIG. 6 differs from the device 40 described in relation with FIG. 4 by the fact that interface layer 41 comprises a peripheral portion made of an adhesive 61 (Adh).

The adhesive enables to bond optical sensor 15 to the first layer 21 comprising the screen.

Adhesive 61 is preferably a non-scattering optically clear adhesive (OCA).

According to an alternative embodiment, adhesive 61 is an adhesive opaque in wavelengths for which optical sensor 15 is sensitive, that is, opaque in wavelengths of the visible spectrum and of near infrared, in the range from 400 to 920 nm. This enables to ease the calibration of the image sensor. Adhesive 61 for example has a refraction index greater than that of the screen, easing the absorption of oblique light in opaque adhesive 61.

FIG. 7 is a cross-section view of still another embodiment of a device 50A comprising an optical sensor under a partially transparent screen.

The device 50A illustrated in FIG. 7 is a combination of the devices 50 and 40A described in relation with FIGS. 4 and 6. Accordingly, starting from a structure such as illustrated in FIG. 4, device 50A further comprises peripheral stacks 51 and a peripheral portion made of an adhesive 61.

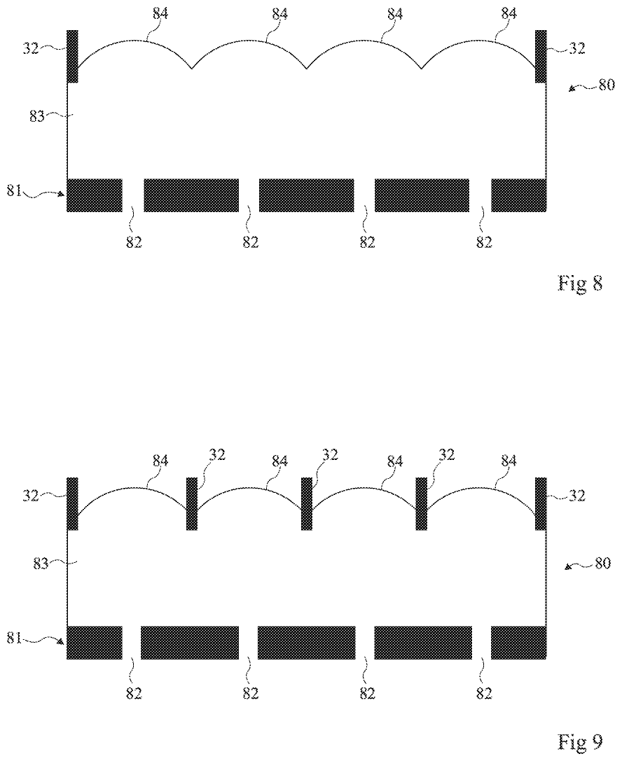

FIG. 8 is a partial cross-section view of an embodiment of an angular filter 80 and of an overlying interface layer.

Angular filter 80 comprise a layer 81 having microopenings 82. Angular filter 80 further comprises an optical material 83 arranged on layer 81. The upper surface of optical material 83, in the orientation of the figure, is shaped to define microlenses 84. Microlenses 84 are arranged opposite the microopenings. According to an alternative embodiment, microlenses 84 are made of a material different from optical material 83. For example, optical material 83 is a layer of polyethylene terephthalate (PET) having an array of microlenses 84 made of resin having a high optical index, typically in the range from 1.5 to 1.6, deposited thereon.

Angular filter 80 is for example formed in accordance with one of the embodiments described in document FR-A-3063596, which is incorporated herein by reference as authorized by law.

Rigid elements 32, for example, micropillars, are arranged to avoid obstructing the microlenses. Preferably, rigid elements 32 are arranged between microlenses 84.

In the example of FIG. 8, four microlenses 84 and two rigid elements 32 are shown. Rigid elements 32, here taking the shape of micropillars, are arranged at an interval of four microlenses. According to an alternative embodiment, the rigid elements may correspond to peripheral portions 61 made of an adhesive illustrated in FIGS. 6 and 7.

Rigid elements 32 are for example made of the same material as optical material 83. In this case, rigid elements 32 and microlenses 84 are manufactured in one and the same step.

According to an alternative embodiment, rigid elements 32 are made of a material, preferably black, filtering wavelengths for which optical sensor 15 is sensitive, that is, opaque in wavelengths of the visible spectrum and of near infrared, in the range from 400 to 920 nm.

According to another alternative embodiment, rigid elements 32 are made of a magnetic shielding material.

According to another alternative embodiment, rigid elements 32 are piezoelectric elements or made of a resistive material.

According to another alternative embodiment, rigid elements 32 are electrodes having their detection function based on a capacitive method.

Rigid elements 32 for example have the function of a support, between the upper surface of angular filter 22 and the lower surface of first layer 21 comprising a screen (not shown in FIG. 8). When a force is applied to the screen (typically under the effect of a user's finger), the screen deforms. The support, provided by the rigid elements, enables to prevent the screen from coming into contact with microlenses 84, and thus to protect the microlenses. In the case where first layer 21 is only supported at its periphery, the space or “air-gap” between the screen and microlenses 84 should be selected to prevent the screen from coming into contact with microlenses 84.

According to an alternative embodiment, rigid elements opaque in wavelengths of the visible spectrum and of near infrared are arranged on at least a peripheral portion of the optical sensor to optically obstruct the peripheral microopenings of the sensor. This enables to ease the calibration of the image sensor.

FIG. 9 is a partial cross-section view of another embodiment of an angular filter 80 and of an overlying interface layer.

The embodiment of FIG. 9 differs from that described in relation with FIG. 8 in that rigid elements 32 are arranged between all microlenses 84. This embodiment thus comprises the maximum possible density of rigid elements.

FIG. 10 is a partial cross-section view of another embodiment of an angular filter 80 and of an overlying interface layer.

The embodiment of FIG. 10 differs from that described in relation with FIG. 9 in that the space 101 between the upper surface of angular filter 22 and the lower surface of screen 21 (not shown in FIG. 10) is filled with an optically clear material, for example, an adhesive having a low optical index (LOCA) or a resin having a low optical index.

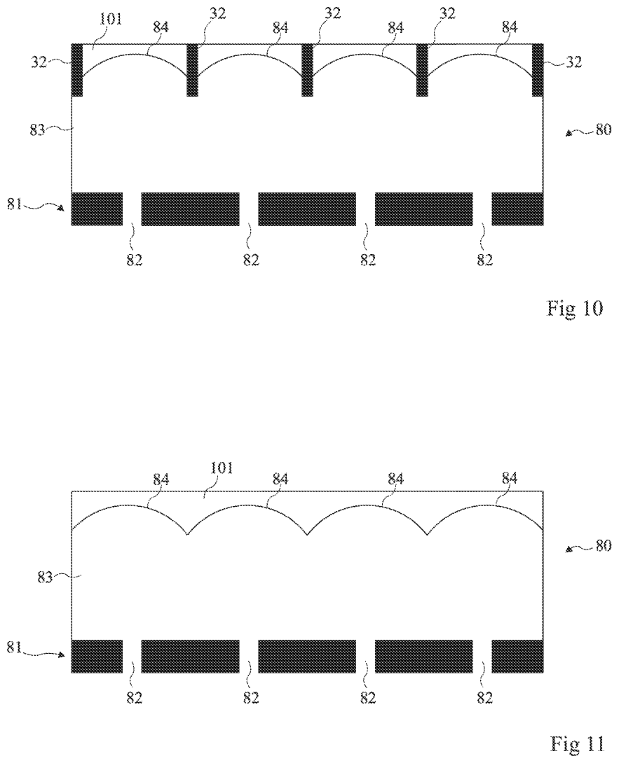

FIG. 11 is a partial cross-section view of still another embodiment of an angular filter 80 and of an overlying interface layer.

The embodiment of FIG. 11 differs from that of FIG. 10 in that no rigid element 32 is present in space 101. Space 101, filled with an optically clear material, for example, an adhesive having a low optical index (LOCA), ensures both the support function and the function of optical interface between the screen and the angular filter.

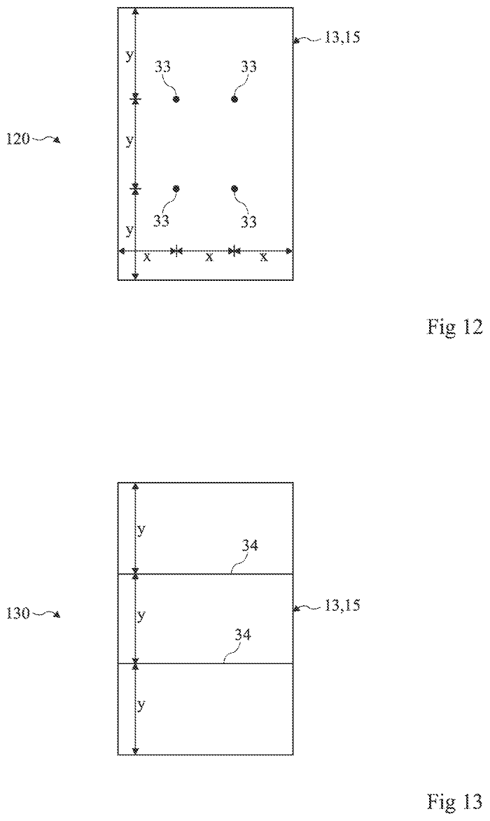

FIG. 12 is a simplified top view of an embodiment of a device 120 comprising an optical sensor under a partially transparent screen.

Device 120 here is a device where screen 13 and optical sensor 15 have the same surface area.

A plurality of rigid elements is at least partially distributed at the surface of optical sensor 15.

According to this embodiment, rigid elements 32 in the shape of pillars 33 are generally arranged with a regular interval to form a pattern. For example, a same interval x horizontally separates, in the orientation of the figure, rigid pillars 33 two by two. The same interval x for example separates the edge of the device from the closest rigid pillars 33.

Similarly, an interval “y” vertically separates, in the orientation of the drawing, rigid pillars 33 two by two. The same interval “y” separates the edge of the device from the closest rigid pillars 33.

Optionally, a rigid element in the form of a peripheral frame is provided between the screen and the optical sensor at the periphery of the device to complete the support function.

In the example illustrated in FIG. 12, four rigid pillars 33 are shown. In practice, a larger number of pillars may be used. The device comprises a same number of horizontal and vertical intervals x and y. Intervals x and y are different due to the aspect ratio of the device.

As a variation, intervals x and y are equal.

FIG. 13 is a simplified top view of another embodiment of a device 130 comprising an optical sensor under a partially transparent screen.

Device 130 differs from the device 120 described in relation with FIG. 12 in that rigid pillars 33 are replaced with rigid horizontal tabs 34.

Similarly to the pillars, the rigid horizontal tabs are preferably arranged between microlenses 84 (not shown in FIG. 13). Rigid horizontal tabs 34 extend at least over a horizontal portion of the device.

Rigid horizontal tabs 34 are generally arranged with a regular interval to form a pattern. For example, a same interval “y” vertically separates, in the orientation of the figure, rigid horizontal tabs 34 two by two. The same interval “y” separates the upper edge and the lower edge of the device from the closest rigid horizontal tabs 34.

In the example illustrated in FIG. 13, two rigid horizontal tabs 34 are shown. The two tabs extend over the entire distance between the left-hand edge and the right-hand edge of device 130.

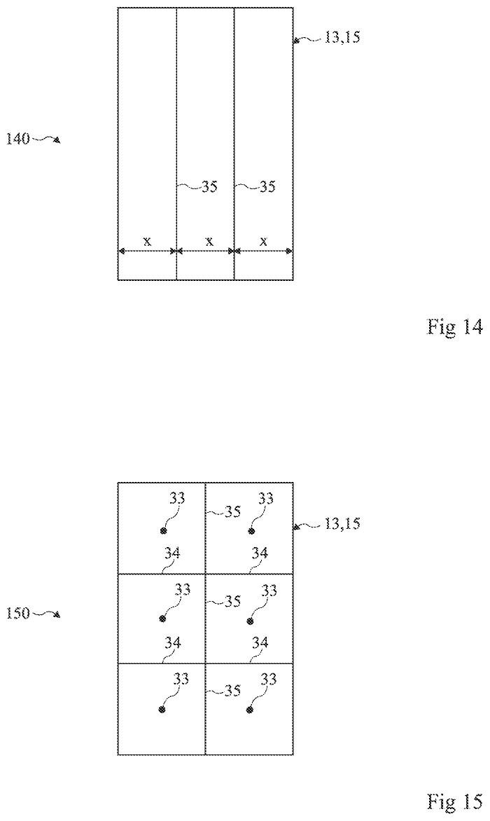

FIG. 14 is a simplified top view of another embodiment of a device 140 comprising an optical sensor under a partially transparent screen.

Device 140 differs from the device 130 described in relation with FIG. 13 in that the rigid horizontal tabs are replaced with rigid vertical tabs 35.

Similarly to the rigid horizontal tabs 34 of FIG. 13, rigid horizontal tabs 35 are preferably arranged between microlenses 84 (not shown in FIG. 14). Rigid horizontal tabs 35 at least partly extend over a vertical portion of the device.

Rigid vertical tabs 35 are generally arranged with a regular interval to form a pattern. For example, a same interval x horizontally separates, in the orientation of the figure, rigid vertical tabs 35 two by two. The same interval x for example separates the left-hand edge and the right-hand edge of the device from the closest rigid vertical tabs 35.

In the example illustrated in FIG. 14, two rigid vertical tabs 35 are shown. The two tabs extend over the entire distance between the upper edge and the lower edge of device 140.

FIG. 15 is a simplified top view of still another embodiment of a device 150 comprising an optical sensor under a partially transparent screen.

Device 150 comprises a combination of support elements, previously described in relation with FIGS. 12, 13, and 14, among which:

rigid pillars 33;

rigid horizontal tabs 34; and

rigid vertical tabs 35.

Support elements 33, 34, and 35 are generally arranged with a regular interval to form a pattern.

In the example of FIG. 15, the device comprises six pillars 33, four horizontal tabs 34 each extending over substantially half of the horizontal portion of the device and three vertical tabs 35 each extending over substantially one third of the vertical portion of the device.

According to an alternative embodiment, horizontal and vertical tabs 34 and 35 form a single complex support element. The complex support element may for example take the shape of a grid or of a honeycomb.

Those skilled in the art will understand that the different patterns and combinations of support elements described in relation with FIGS. 12 to 15 are compatible with an embodiment where the device comprises an optical sensor 15 having a surface area smaller than that of screen 13.

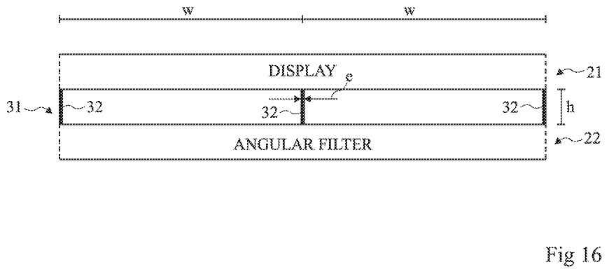

FIG. 16 is a partial cross-section view illustrating a detail of an embodiment of a device comprising an optical sensor under a partially transparent screen.

FIG. 16 is a partial view of the device such as described in relation with FIG. 3.

This drawing illustrates a portion of first layer 21, a portion of second layer 22, and a portion of level 31 comprising three rigid elements 32. The interval or horizontal pitch w between rigid elements 32 two by two is constant in the present example. All the rigid elements have an identical height h. Height h is generally in the range from 1 to 300 micrometers, preferably from 1 to 150 micrometers, preferably from 1 to 50 micrometers. Preferably, the interval w between rigid elements 32 two by two is in the range from 1 to 67 micrometers. Preferably, the width or thickness “e” of the rigid elements is in the range from 1 to 67 micrometers.

According to an alternative embodiment, the interval between the rigid elements two by two is not constant. In this case, the interval between rigid elements 32 two by two is in the range from 1 to 67 micrometers.

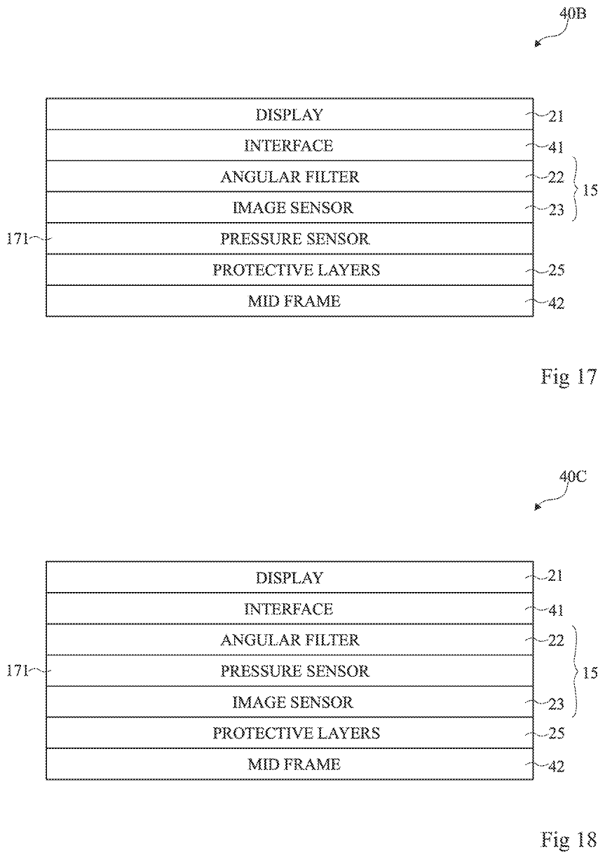

FIG. 17 is a cross-section view of an embodiment of a device 40B comprising an optical sensor under a partially transparent screen, further comprising a pressure sensor.

The device 40B shown in FIG. 17 differs from the device 40 described in relation with FIG. 4 by the fact that it further comprises a layer 171, comprising a pressure sensor (PRESSURE SENSOR). Layer 171 is arranged between the layer 23 comprising the image sensor and stack 25. In other words, the pressure sensor is arranged under optical sensor 15.

A pressure sensor enables to determine an attempt of activation of the optical sensor by a user (typically to read his/her fingerprint). This enables to only activate the optical sensor in case of need and thus decreases the consumed power. A possible configuration would be to activate the image sensor to recover the user's fingerprint if a pressure on the screen is present for a given time period, for example, one second.

FIG. 18 is a cross-section view of another embodiment of a device 40C comprising an optical sensor under a partially transparent screen, further comprising a pressure sensor.

The device 40C shown in FIG. 18 differs from the device 40B described in relation with FIG. 17 by the fact that the pressure sensor (PRESSURE SENSOR) is arranged between the second layer 22 comprising the angular filter and the third layer 23 comprising the image sensor.

In this embodiment, the pressure sensor (PRESSURE SENSOR) is integrated to optical sensor 15. Since it is located above the image sensor, the pressure sensor is preferably made of an optically clear material, and/or locally arranged at the edge of optical sensor 15 or between the sensor photodiodes.

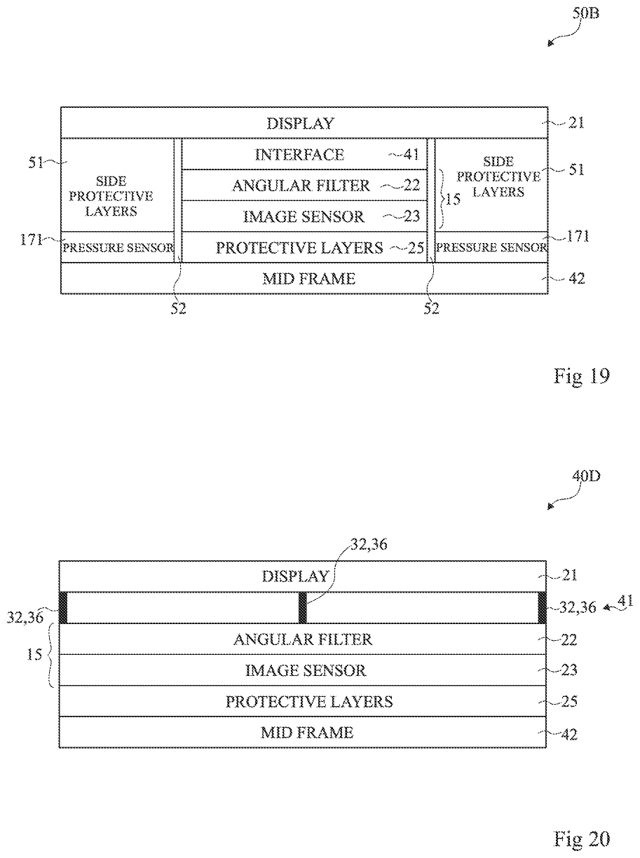

FIG. 19 is a cross-section view of another embodiment of a device 50B comprising an optical sensor under a partially transparent screen, further comprising a pressure sensor.

The device 50B shown in FIG. 19 differs from the device 50 described in relation with FIG. 5 in that the device comprises, at its periphery, layers 171, comprising a pressure sensor (PRESSURE SENSOR). Layers 171 are arranged between peripheral stacks 51 and frame 42.

FIG. 20 is a cross-section view of still another embodiment of a device 40D comprising an optical sensor under a partially transparent screen, further comprising a pressure sensor.

The device 40D shown in FIG. 20 comprises the layers of FIG. 4, considering that interface layer 41 comprises rigid elements 32. According to an embodiment, elements 32 (pillars or tabs) integrate pressure sensors 36. In other words, pressure sensors 36 are arranged on optical sensor 15.

According to an embodiment, pressure sensors 36 are formed by the actual rigid elements which then are piezoelectric elements or made of a resistive material.

According to another embodiment, pressure sensors 36 are formed of distinct elements arranged under at least a portion of rigid elements 32.

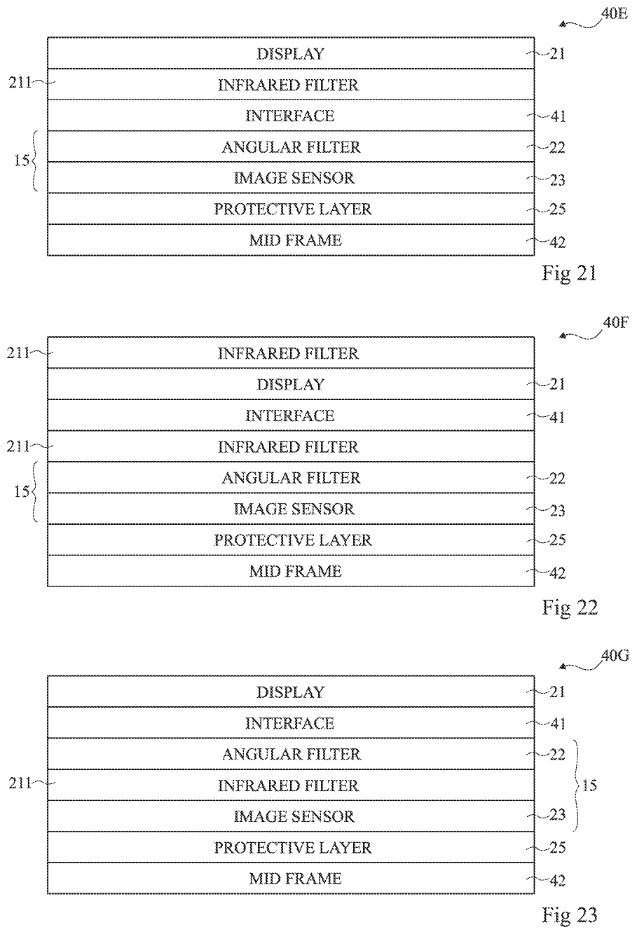

FIG. 21 is a cross-section view of an embodiment of a device 40E comprising an optical sensor under a partially transparent screen, further comprising an infrared filter.

The device 40E shown in FIG. 21 differs from the device 40 described in relation with FIG. 4 by the fact that it comprises a layer 211 comprising an infrared filter (INFRARED FILTER). The infrared filter has a cutoff wavelength preferably at 600 nm and a 0.1% transmittance corresponding to an optical density OD3, from 600 nm to 920 nm, or from 600 nm to the maximum wavelength absorbed by the image sensor. For example, in the case where the optical sensor absorbs wavelengths up to 700 nm, the filter is designed to filter wavelengths from 600 nm to 700 nm. Layer 211 is arranged between first layer 21 comprising a screen and interface layer 41.

FIG. 22 is a cross-section view of still another embodiment of a device 40F comprising an optical sensor under a partially transparent screen, further comprising an infrared filter.

The device 40F shown in FIG. 22 differs from the device 40 described in relation with FIG. 4 by the fact that it comprises two layers 211 each comprising an infrared filter (INFRARED FILTER). Layers 211 are respectively arranged on the first layer 21 comprising a screen and between interface layer 41 and second layer 22 comprising an angular filter.

As a variation, only one of the two layers 211 may be provided.

FIG. 23 is a cross-section view of still another embodiment of a device 40G comprising an optical sensor under a partially transparent screen, further comprising an infrared filter.

The device 40G shown in FIG. 23 differs from the device 40E described in relation with FIG. 21 by the fact that the infrared filter (INFRARED FILTER) is arranged inside of optical sensor 15, between the second layer 22 comprising an angular filter and the third layer 23 comprising an image sensor.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove. In particular, the selection of the adhesives of low optical index used depends on the optical and/or structural needs of the implemented embodiment.

1. A device comprising:
an at least partially transparent screen;
an optical sensor; and
between the sensor and the screen, at least one rigid element is arranged between microlenses of the optical sensor.

2. The device according to claim 1, wherein the at least one rigid element is a pillar.

3. The device according to claim 1, wherein the at least one rigid element is a tab.

4. The device according to claim 1, wherein the at least one rigid element has a height, said height being in the range: from 1 to 300 micrometers, from 1 to 150 micrometers, or from 1 to 50 micrometers.

5. The device according to claim 1, wherein an interval between the at least one rigid element and a second rigid element is in the range from 1 to 67 micrometers.

6. The device according to claim 1, wherein the at least one rigid element is a support element between the screen and the optical sensor.

7. The device according to claim 1, wherein the at least one rigid element is made of a same material as an optical material of the optical sensor.

8. The device according to claim 1, wherein the at least one rigid element is made of a material filtering wavelengths in the range from 400 to 920 nm, or black.

9. The device according to claim 1, wherein the at least one rigid element is made of an electromagnetic shielding material.

10. The device according to claim 1, wherein the at least one rigid element is a piezoelectric element or is made of a resistive material.

11. The device according to claim 1, further comprising a layer between the screen and the optical sensor the layer having at least one non-scattering optically clear portion having a refraction index smaller by at least 0.1, or by at least 0.15, than the refraction index of an optical material of the optical sensor.

12. The device according to claim 11, wherein said non-scattering optically clear portion is:
made of air; or
made of an adhesive having a low optical index; or
made of a resin having a low optical index.

13. The device according to claim 1, wherein the optical sensor has the same surface area as the screen.

14. The device according to claim 1, wherein the optical sensor has a surface area smaller than that of the screen.

15. The device according to claim 1, wherein the device comprises one or more pressure sensors.

16. The device according to claim 15, wherein:
the one or more pressure are arranged at a periphery of the optical sensor; and/or
the one or more pressure sensors are arranged under the optical sensor; and/or
the one or more pressure sensors are arranged on the optical sensor; and/or
the one or more pressure sensors are arranged under at least a portion of the at least one rigid element; and/or
the one or more pressure sensors are integrated to the at least one rigid element.

17. The device according to claim 1, wherein the optical sensor is a fingerprint sensor.

18. The device according to claim 1, wherein the device comprises at least one infrared filter, having a cutoff wavelength at 600 nm and a 0.1% transmittance from 600 nm to 920 nm, arranged:
between said screen and a layer between the screen and the optical sensor; and/or
between said screen and a screen protection glass; and/or
between said layer and the optical sensor; and/or
in the optical sensor.

19. A cell phone comprising the device according to claim 1.
